(19) United States
(12) Patent Application Publication
(10) Pub. No.: US 2010/0026489 A1
(43) Pub. Date: Feb. 4, 2010

(54) SECURITY DEVICE AND SECURITY SYSTEM USING THE SAME

(75) Inventors: Raymond Jordan, Holtsville, NY (US); Richard J. Laube, Holtsville, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/182,430

(22) Filed: Jul. 30, 2008

(51) Int. Cl. G08B 13/24

(52) U.S. Cl. 340/551; 340/541

(57) ABSTRACT

The present invention relates to a security device used in connection with an access barrier of a protected area. The access barrier is movable between an open position and a closed position for selectively permitting ingress and egress to the protected area. The device has an access barrier position detector to detect the position of the access barrier and generate a status signal indicative of the access barrier being open or closed. The device also has a lock position detector to detect the position of a lock for selectively locking and unlocking the access barrier and generate a status signal indicative of the access barrier being locked or unlocked. A signal transmitter is provided to transmit the status signals.

### FIELD OF THE INVENTION

The present invention generally relates to security systems. More particularly, the present invention relates to a security device operated in conjunction with an access barrier, such as a door or window, for selectively permitting ingress and egress to a protected area, and a security system utilizing the security device to monitor the protected area.

### BACKGROUND OF THE INVENTION

Generally, a security system includes one or more security devices, such as window sensors/contacts and door sensors/contacts, to determine the presence of objects within a residential or business premises. The security system typically comprises a control panel having necessary processing capability to determine whether signal information received from the security devices is indicative of an intrusion, and a user interface, such as a keypad, for operational programming functions to permit a user to arm or disarm the security system.

Typically, for an enclosed premises monitored by a series of security devices, the security system responds to a breach of the area based on the state of the system, which include “disarmed”, “armed stay”, and “armed away.” If the system is disarmed it will not issue alarms due to an ingress or egress to the premises. If the system is armed stay, it will issue alarms responsive to an ingress or an egress to the premises if entry and/or exit time has expired. If the system is armed away it will issue alarms based on either an ingress or egress of the premises. The state of the system is determined by the needs of the occupants of the premises. If all of the occupants are leaving the premises then the system should be armed away. If the occupants will be staying within the premises for an extended period of time then the system should be armed stay. For all other scenarios the system should be disarmed.

Conventionally, a user of the security system can arm the system to the states of “armed stay” or “armed away” by inputting a unique user sequence or code into the keypad, to provide that all the monitored zones of the premises are closed and/or the faulted zones of the premises are bypassed. In that case, the armed security devices, such as the various door and window sensors or contacts, form a loop to determine whether a specific zone is closed.

The conventional security devices, mounted to the doors or windows of a monitored zone, form a loop indicating the zone is closed, once all the doors or windows are closed. This would present a false sense of security to the user because the door or window may not be actually locked. For example, when a user is ready to exit the premises and activates the security system, a short delay is usually provided to allow the user to have sufficient time to exit an access door without setting off a false alarm. If in this case the door is not locked and the control panel still shows that the protected zones of the premises are closed, a false sense of security might be presented to the user. After the user leaves, an intruder might break in the premises before the short delay expires and disarm the entire security system.

Thus, it would be advantageous to provide a security system that would eliminate the false sense of security incurred by the conventional security system. It would also be advantageous to provide a security device, which not only examines the closing of the windows or doors, but also examines the locking of the windows or doors. It would also be advantageous to provide a method of monitoring a security area by providing double loops for determining whether the area is closed and whether windows or doors, are locked.

### BRIEF SUMMARY OF THE INVENTION

According to one aspect of the present invention, a security device used in connection with an access barrier of a protected area, movable between an open position and a closed position for selectively permitting ingress and egress to the protected area is provided. The device includes an access barrier position detector, configured to detect the position of the access barrier and generate an access barrier status signal indicative of the access barrier being open or closed in response to the detected position of the access barrier; a lock position detector, configured to detect the position of a lock operatively coupled to the access barrier for selectively locking and unlocking the access barrier and generate a lock status signal indicative of the access barrier being locked or unlocked in response to the detected position of the lock; and a signal transmitter, configured to transmit the access barrier status signal and the lock status signal.

According to one aspect of the present invention, a security system for monitoring a protected area is provided. The system includes a security device and a control panel in communication with the security device. The security device is used in connection with an access barrier of the protected area, the access barrier movable between an open position and a closed position for selectively permitting ingress and egress to the protected area. The security device includes an access barrier position detector, configured to detect the position of the access barrier and generate an access barrier status signal indicative of the access barrier being open or closed in response to the detected position of the access barrier; a lock position detector, configured to detect the position of a lock operatively coupled to the access barrier for selectively locking and unlocking the access door and generate a lock status signal indicative of the access barrier being locked or unlocked in response to the detected position of the lock; and a signal transmitter, configured to transmit the access barrier status signal and the lock status signal. The control panel includes a signal transceiver, configured to receive and transmit the access barrier status signal and the lock status signal transmitted by the signal transmitter; and a processor, configured to process the access barrier status signal and the lock status signal and generate a security status message of the monitored area based on the processing of the access barrier status signal and the lock status signal.

According to another aspect of the present invention, a method for monitoring a security device used in connection with an access barrier of the protected area is provided. The access barrier is movable between an open position and a closed position for selectively permitting ingress and egress to the protected area. The method includes detecting the position of the access barrier, generating an access barrier status signal indicative of the access barrier being open or closed in response to the detected position of the access barrier, detecting the position of a lock of the access barrier for selectively locking and unlocking the access door, generating a lock status signal indicative of the access barrier being locked or unlocked in response to the detected position of the lock, and processing the access barrier status signal and the lock status signal to generate a security status message of the monitored area.

### BRIEF DESCRIPTION OF THE DRAWINGS

These and other objects, features and advantages of the present invention will become apparent from the following detailed description of exemplary embodiments to be read in connection with the accompanying drawings, in which:

FIG. 1 is a block diagram of a security system according to an exemplary embodiment of the present invention;

FIG. 2 is a partial perspective view of a security device according to an exemplar embodiment of the present invention, the security device being used in connection with an access barrier, such as a window, of a protected area;

FIG. 3 is a perspective view of the security device shown in FIG. 2;

FIG. 4 is a flow chart illustrating a method for operating a security system according to an exemplary embodiment of the present invention;

FIG. 5 is flow chart illustrating a method for operating a security system according to another exemplary embodiment of the present invention;

FIG. 6 is a flow chart illustrating a method for operating a security system according to another exemplary embodiment of the present invention; and

FIG. 7 is a flow chart illustrating a method for operating a security system according to another exemplary embodiment of the present invention.

### DETAILED DESCRIPTION OF THE INVENTION

The present invention now will be described in detail hereinafter with reference to the accompanying drawings, in which exemplary embodiments of the invention are shown. However, this invention may be embodied in many different forms and should not be construed as limited to the embodiments set forth herein. Like numerals refer to like elements throughout.

As used herein, “configured to” and the like refer to mechanical or structural connections between elements to allow the elements to cooperate to provide a described effect; these terms also refer to operation capabilities of electrical elements, such as analog or digital computers, and specific devices that are programmed to perform a series of steps to provide an output in response to given input signals.

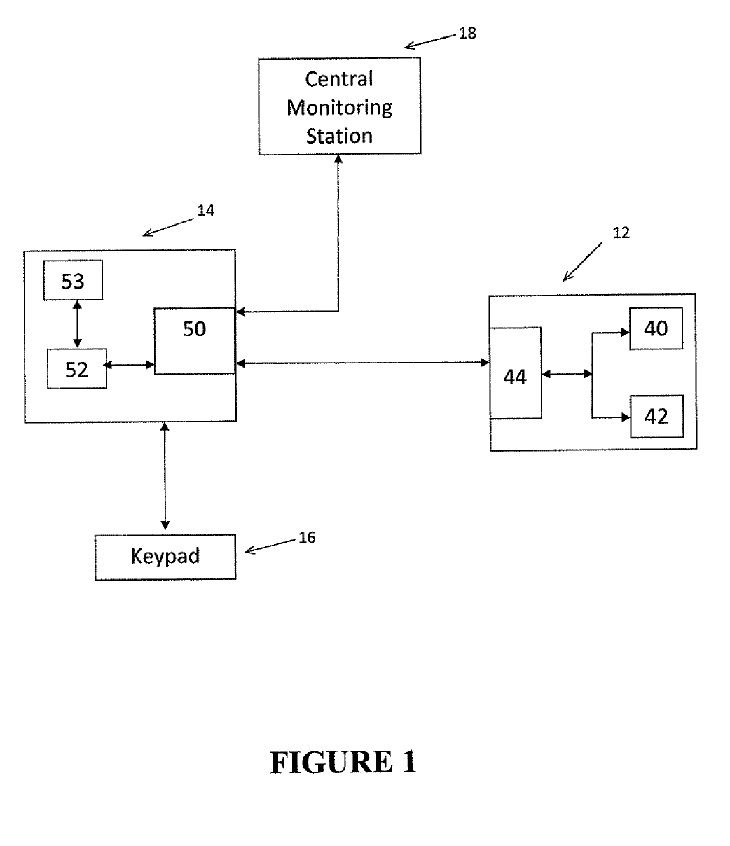

FIG. 1 illustrates a block diagram of a security system 10 according to an exemplary embodiment of the present invention. The security system 10 includes a security device 12 and a control panel 14, coupled to each other through wired or wireless communication well known in the art, such as a cable or wireless link. The security device 12 functions to detect an event, such as a breach of the protected premises, and transmit signals in response to the event. The functions implemented by the security control panel 14 include processing the signals from the security device 12, arming and disarming the system, providing system status, coordinating the operations of other functional modules of the system, and so on.

The security system 10 may further includes an interface 16 for a user to input instructions and/or codes to the control panel 14. The interface 16 in FIG. 1 is shown as a keypad, through which the user views status of the system, i.e., all secure and enters a valid sequence to the control panel 14 to arm or disarm the security system 10. The security system 10 optionally includes a central monitoring station 18 in communication with the control panel 14, for receiving, routing and sending alert signals or messages generated by the control panel 14 to a user and/or reporting the occurrence of an intrusion to the police or security personnel.

The security device 12 may be employed in conjunction with various access barriers of the premises monitored by the security system 10. The access barriers are typically movable between an open position and a closed position to selectively permit ingress and egress to the monitored premises. At least one lock is mounted to the access barriers to lock and unlock the access barriers once the access barrier is in the closed position. The access barriers include, but are not limited to, doors or gates, windows, skylights or other closing structures for commercial or residential premises. The access barriers may assume any suitable shape or configuration, such as linear, curved or nonlinear, in whole or in part. In addition, the access barriers may be constructed from a variety of materials such as wood, metal, plastics, or various combinations thereof. The lock can be any suitable lock operated by a key or a user's finger, or electrically controlled by a swipe card or a keypad. Optionally, the lock can be operated and controlled wirelessly through any known wireless technology.

As shown in FIG. 1, the security device 12 includes an access barrier position detector 40, a lock position detector 42 and a signal transmitter 44. The access barrier position detector 40 functions to detect the position of an access barrier, such as a door or a window, to determine whether the access barrier is open or closed. The access barrier position detector 40 further generates a signal indicative of the status of the access barrier as being open or closed in response to the detected position of the access barrier. The lock position detector 42 functions to detect the position of a lock mounted to the access barrier to determine whether the access barrier is locked or unlocked. The lock position detector 40 further generates a signal indicative of the status of the access barrier as being locked or unlocked in response to the detected position of the lock.

The signal transmitter 44 receives the signals generated by the access barrier position detector 40 and the lock position detector 42, and further transmits the signals to the control panel 14. The signal transmitter 44 may be, for example, an RF wireless transmitter or a wired transmitter. The security device 12 according to the exemplary embodiment of the invention can be integrated into a single unit or provided as separate components. The security device 12 may be assembled with an access barrier or a lock of the access barrier as a subsystem or retrofit into an existing access barrier or lock.

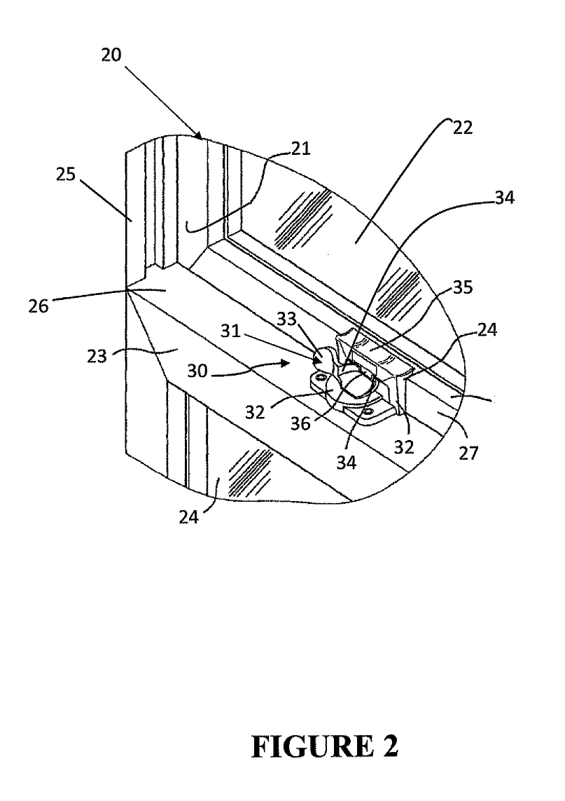

FIG. 2 illustrates the security device 12 used in conjunction with a window 20. The window 20 is, for example, a double hung type window including an upper movable frame member 21 accommodating an upper pane 22 and a lower movable frame member 23 accommodating a lower pane 24. The upper frame member 21 and the lower frame member 23 are slidably fitted into a window frame 25 mounted to an opening (not shown) of a wall of the premises. The upper frame member 21 and the lower frame member 23 can be moved upwardly and downwardly or rotated around a hinge (not shown), to provide an access to the monitored premises.

The window 20 further includes a lock 30 mounted to the window 20 for locking and unlocking the window 20. The lock 30 includes a latch 31 pivotably fixed to an upper rail 26 of the lower frame member 23 through a support member 32. The latch 31 includes a finger lever 33 for pivoting the latch 31 by a finger, and a curved latching cup 34 extending from the finger lever 33. The lock 30 further includes a receiver 35 fixed to a lower rail 27 of the upper frame member 21. The latch 31 and the receiver 35 are positioned and dimensioned such that, when the window 20 is closed and the latch 31 and the receiver 35 are engaged. Relative movement of the upper frame member 21 and the lower frame member 23, thereby locking the window 20. Specifically, the receiver 35 includes a keeping tab 36 operatively engaging the curved latching cup 34 when the latch 31 is pivoted from an unlocked position (not shown) to a locked position.

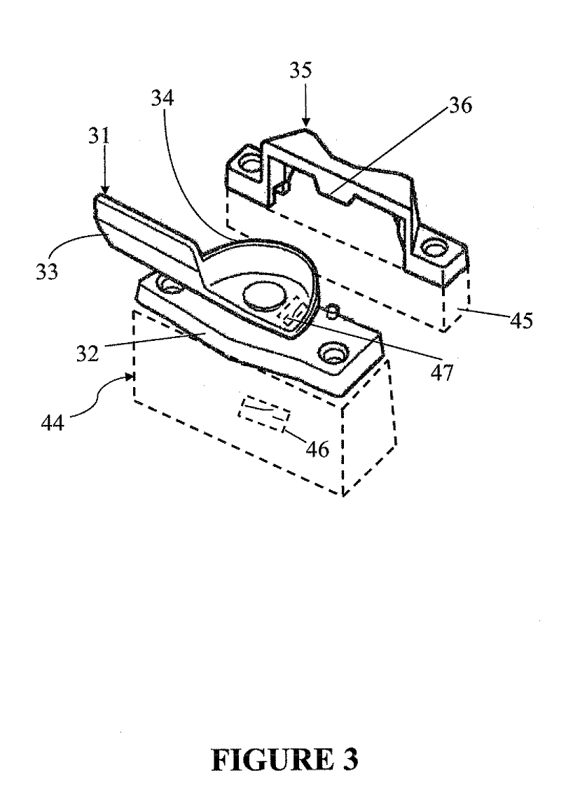

The access barrier position detector 40 of FIG. 1 is shown as a window position detector in FIG. 3, for sensing the position of the upper frame member 21 relative to the lower window frame member 23, to determine the status of the window 20 as being open or closed. In the exemplary embodiment shown in FIG. 3, the window position detector includes a magnetic member 45 mounted between the receiver 35 of the lock 30 and lower rail 27 of the upper frame member 21, and a magnetic switch 46 mounted to the upper rail 26 of the lower frame member 23. The magnetic member 45 is used to change the states of the magnetic switch 46 in response to the relative positions of the upper frame member 21 and the lower frame member 23. Specifically, when the window 20 is closed to bring the magnetic member 45 into substantial contact with the magnetic switch 46, a magnetic flux is generated between the magnetic member 45 and the magnetic switch 46 to change the state of the magnetic switch 46. Under such a condition, a signal indicative of the status of the window 20 as being closed is generated by the magnetic switch 46 and further sent to the transmitter 44. On the other hand, when the window 20 is opened to separate the magnetic member 45 and the magnetic switch 46, the magnetic flux is interrupted to change the state of the magnetic switch 46. Under such a condition a signal indicative of the status of the window 20 as being open is generated by the magnetic switch 46 and further sent to the transmitter 44. The transmitter 44 sends the collected status signals to the control panel 14 for further processing to determine the security status of the monitored premises.

However, it should be understood that other types of window position detecting arrangement or configuration can be used to detect the position of the window or used together with the magnetic switch mechanism described above. In addition, the detector is applicable to any other type of access barriers, including but not limited to doors, gates and skylight, for selectively providing access to a monitored premises.

The lock position detector 42 in FIG. 1 is shown as a contact switch 47 in FIG. 3, which serves to sense the position of the lock 30, especially the position of the latch 31, relative to the receiver 35 as well as the window 20, so as to determine the status of the lock 30 as being locked or unlocked. The lock position detector 42 is normally open, and is closed when the latch 31 is in the closed position, as shown in FIG. 3. In the exemplary embodiment, the contact switch 47 is mounted on the support member 32 and adapted to contact the latch 31 when a user applies a force to the finger lever 33 to pivot the latching cup 34 into locked position. The window 20 is locked by the engagement of the latching cup 34 and the keeping tab 36. Once the window 20 is closed to send out a signal indicative of the window closing status and the contact switch 47 contacts the latching cup 34, the contact switch 47 is closed to generate a status signal indicative of the window 20 as being locked. Oppositely, when the latch 31 is pivoted to release the engagement with the keeping tab 36, the contact switch 47 is open and a status signal is generated by the contact switch 47 to indicate that the window 20 is not locked. In this way, the transition of the latch 31 from an unlocked position to a locked position is used to generate and send status signals indicative of the locking status of the window 20.

The status signal indicative of the locking status of the window 20 is sent to the transmitter 44. The transmitter 44 sends the signals to the control panel 14, which may in turn provide visual or audio indications showing whether the window 20 is locked or not based on the status signals of the lock 30. In this way, it can be ensured that the window 20 is not only closed but also locked by the lock 30. Thus, a false sense of security, incurred by the fact that the window 20 is only closed but not locked, can be eliminated.

In the illustrated exemplary embodiment, the lock position detector 42 is shown as a contact switch 47, which is normally open and is closed when the latch 31 is in the closed position, as best shown in FIG. 3. In the exemplary embodiment, the contact switch 47 is mounted on the support member 32 and adapted to contact the latch 31 when a user applies a force to the finger lever 33 to pivot the latching cup 34 into the locked position. The window 20 is locked by the engagement of the latching cup 34 and the keeping tab 36. Once contact switch 47 contacts the latching cup 34, the contact switch 47 is closed to generate a status signal indicative of the window 20 as being locked. Oppositely, when the latch 31 is pivoted to release the engagement with the keeping tab 36, the contact switch 47 is open and a status signal is generated by the contact switch 47 to indicate that the window 20 is not locked. In this way, the transition of the latch 31 from an unlocked position to a locked position is used to generate and send status signals indicative of the locking status of the window 20.

It should be understood that any suitable arrangement or configuration can be used as a detector to sense the position of the lock and generate a status signal indicating the locking status of the window, such as microwave switches and optical switches. For example, the lock position detector 42 may include a magnetic switch and a corresponding magnetic member mounted respectively to the support member 32 and the latch 31, similar to the arrangement of the magnetic member 45 and magnetic switch 46 of the access barrier position detector 40. Furthermore, the location of the detector can be varied depending on the application circumstances of the detector. For example, the contact switch 47 may be mounted to the latch 31 instead of the support member 32.

The transmitter 44 further transmits the status signals to the control panel 14 for additional processing. Now, referring back to FIG. 1, the control panel 14 includes a transceiver 50 for implementing the signal transmission between the security device 12 and the control panel 14 and the signal transmission between the control panel 14 and the central monitoring station 18. The transceiver 50 receives status signals from the transmitter 44 and sends the signals to a processor 52 associated with the control panel 14 for processing the status signals.

The status signals generated by the window position detector 40, indicative of the opening and closing status of the window 20, are fed to the processor 52 through the transmitter 44 and the transceiver 50. The status signals generated by the lock position detector 42, indicative of the locking and unlocking status of the window 20, are also fed to the processor 52 through the transmitter 44 and the transceiver 50. Based on the received status signals, the processor 52 generates a message indicating the security conditions of the monitored premises, and further sends the message to a display 53 for displaying the message.

Particularly, under the condition the security system 10 is armed stay or armed away, if the status signal generated by the window position detector 40 indicates the window is closed and the status signal generated by the lock position detector 42 indicates that the window is locked, the processor 52 generates a message enclosing a segment “Armed Away/Stay, All Secure” or “Armed Away/Stay, All Locked” and sends the message to the display 53 for displaying the segment, which gives a user visual indication that the premises is all secure. Alternatively, the processor 52 can generate a message enclosing an audio segment and send it to a speaker (not shown) for vocalizing the security condition of the monitored premises. The display 53 and/or the speaker may be integrated to the control panel 14, or disposed separately from the control panel 14, as long as the arrangement provides convenience to the user. Optionally, the display 53 and the speaker can be combined to enhance the functionality of the system informing the user of the security status of the premises.

Optionally, the processor 52 sends the signals generated by processing of the status signals provided by the security device 12 to the central monitoring station 18 through any known wired or wireless manner. Based on the signal, the central monitoring station 18 may implement further functionalities, such as sending a security condition report to the user or the police.

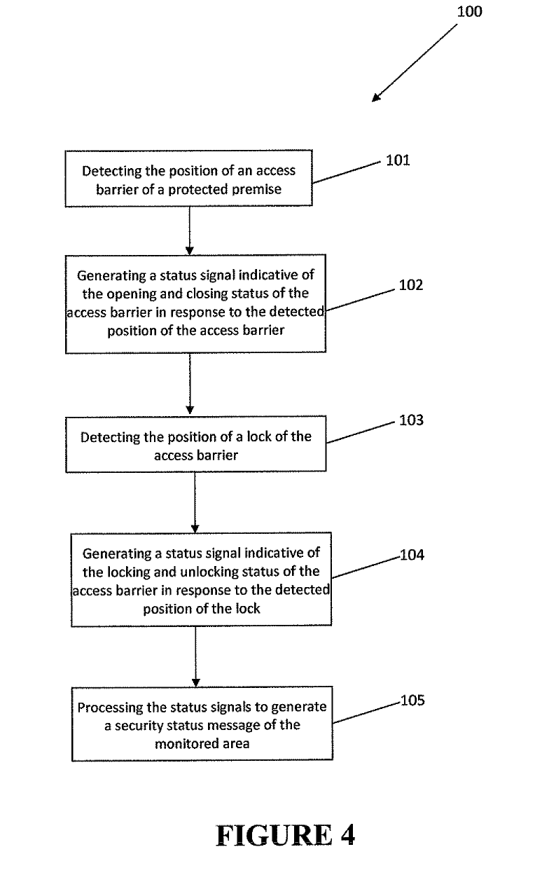

FIG. 4 is a flow chart illustrating a method 100 of monitoring a security device to ensure a monitored premises is secure, according to one exemplary embodiment of another aspect of the present invention. At step 101, the position of an access barrier, such as a window or a door, is detected. At step 102, an access barrier status signal indicating whether the access barrier is open or closed is generated in response to the detected position of the access barrier. At step 103, the position of a lock of the access barrier for selectively locking and unlocking the access door is detected. At step 104, a lock status signal indicating whether the access barrier is locked or unlocked is generated in response to the detected position of the lock. At step 105, the access barrier status signal and the lock status signal are processed to generate a security status message indicating whether the monitored premises is secure.

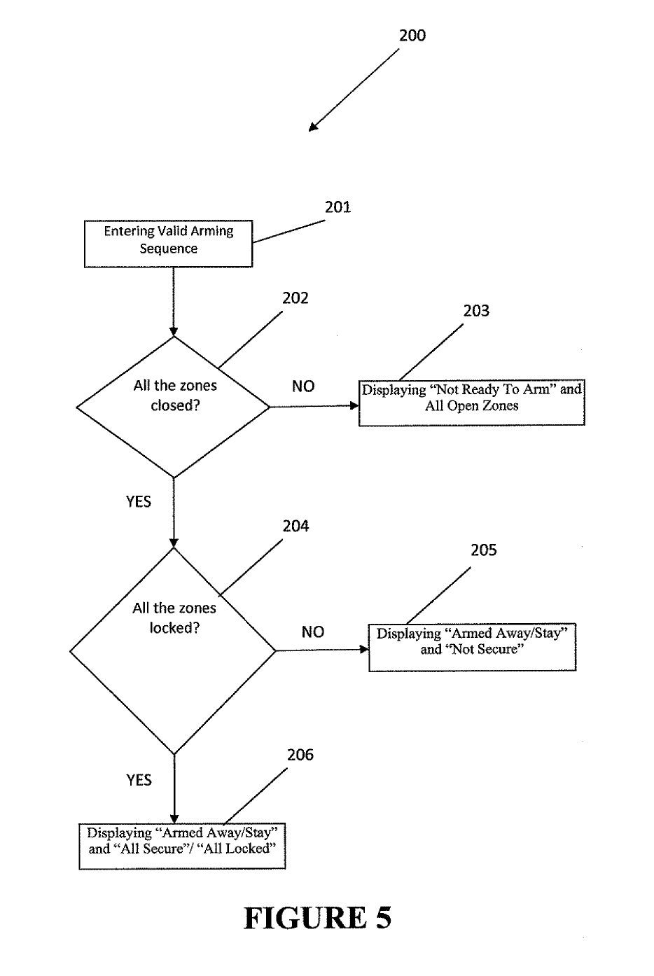

FIG. 5 is a flow chart illustrating a method 200 for operating a security system according to another exemplary embodiment of the present invention. At step 201, a valid arming sequence and/or code is inputted to the security system through an interface, such as a keypad, to arm the security system. At this step, the operational state of the security system, either armed array or armed stay, is also decided in accordance with the sequence and/or code inputted to the security system. At step 202, it is determined whether all the zones in the monitored premises are closed and/or the faulted zones are bypassed. Specifically, it is determined at this step whether all the access barriers, such as the doors and windows, are closed to provide a closed loop of the perimeter of the monitored premises.

If not all the zones in the monitored premises are closed, the method 200 proceeds to step 203, at which the control panel of the security system displays that the security system is not ready to arm since not all of the monitored zones are closed. The control panel further displays all the open zones in the premises by their zone numbers. Otherwise, the method 200 proceeds to step 204, at which it is determined whether all the closed zones in the premises are secure, and specifically whether all the access barriers, such as the doors and the windows, are locked. If at least one of the access barriers is not locked, the method 200 proceeds to step 205, at which the control panel displays that the security system is armed, i.e., all the zones in the premises are closed, but the premises is not secure because at least one door or window is not locked.

Otherwise, the method 200 proceeds to step 206, at which the control panel displays “Armed Away/Stay, All Secure” or “Armed Away/Stay, All Locked”, meaning that the security system is armed and all the closed zones in the premises are secure because all the doors or windows are not only closed but also locked.

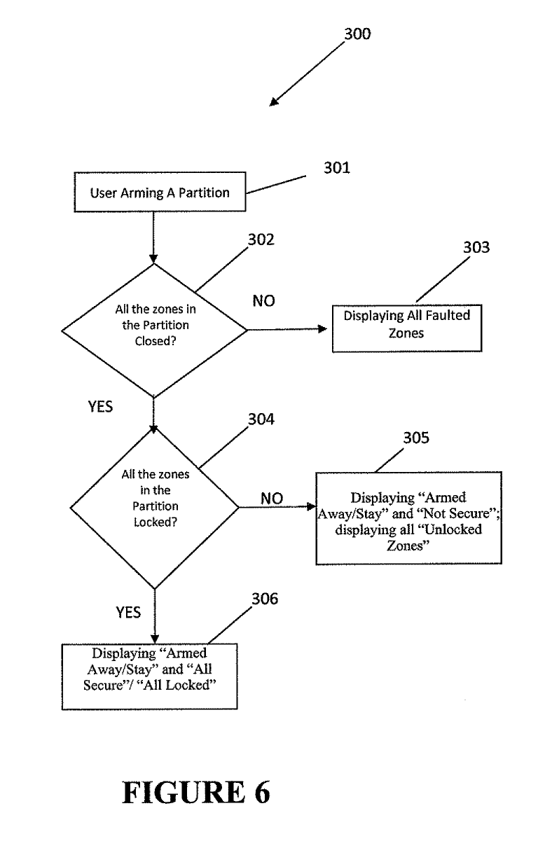

FIG. 6 is a flow chart illustrating a method 300 for operating a security system according to another exemplary embodiment of the present invention. The method 300 is for a user to interactively set up a secure partition within the monitored premises.

At step 301, the user arms the partition in a known manner. At step 302, it is determined whether all the zones in the partition are closed and/or the faulted zones are bypassed. Specifically, it is checked at this step whether all the access barriers, such as the doors and windows, in the partition are closed to provide a closed loop of the perimeter of the secure partition.

If not all the zones in the secure partition are closed, the method 300 proceeds to step 303, at which the control panel of the security system displays all the faulted zones by their numbers. Otherwise, the method 300 proceeds to step 304, at which it is determined whether all the access barriers, such as the doors and the windows, in the secure partition are locked. If at least one of the access barriers is not locked, the method 300 proceeds to step 305, at which the control panel displays that the security system is armed, but the partition is not secure because at least one door or window is not locked. The control panel may further display the unlocked zones by their numbers.

Otherwise, the method 300 proceeds to step 306, at which the control panel displays “Armed Away/Stay, All Secure” or “Armed Away/Stay, All Locked”, meaning that the security system is armed and all the closed zones in the partition are secure because all the doors or windows are not only closed but also locked.

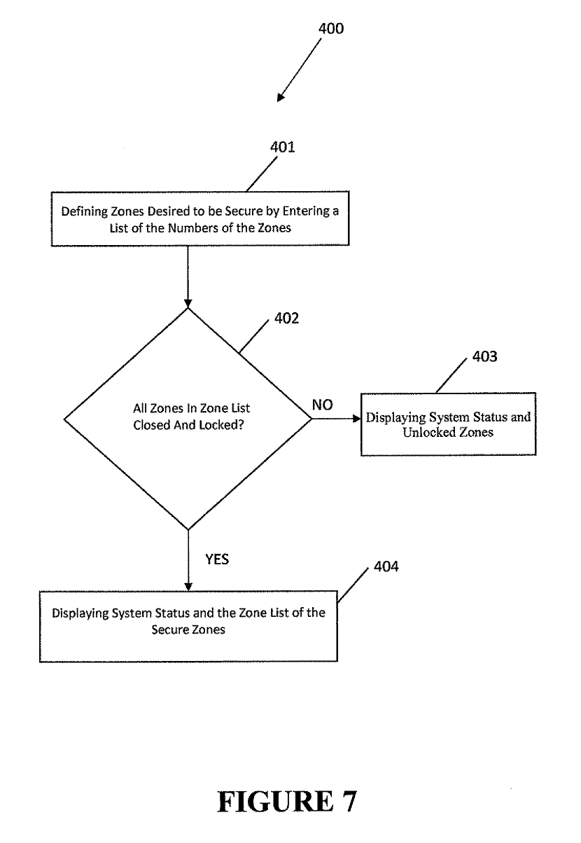

FIG. 7 is a flow chart illustrating a method 400 of monitoring a security device according to another exemplary embodiment of the present invention. The method 400 is for a user to interactively define and set up secure zones within a premises. Specifically, the user can define what zones he wants to be secure and further ensure that all these zones are closed and locked, regardless of the armed or disarmed state of the system.

At step 401, the user defines one or more zones desired to be secure by entering a list of the numbers of the selected zones. The zones could be, for example, basement, fire doors, gun cabinet, liquor cabinet and so on. At step 402, it is determined whether all the selected zones are closed and locked by checking the closing status and locking status of the windows and doors of the selected zones. This step can be implemented by the method 100 shown in FIG. 4.

If not all the selected zones are closed and locked, the method 400 proceeds to step 403, at which the security panel displays the status of the system, such as “Disarmed”, “Armed Stay/Away”, “Ready to Arm”, “Not Ready to Arm”, and the list of zones which are not locked. Otherwise, the method 400 proceeds to step 404, at which the security panel displays the status of the system and the list of secure zones, i.e., all the windows and doors of the zones are closed and locked.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A security device used in connection with an access barrier of a protected area, the access barrier movable between an open position and a closed position, comprising:
an access barrier position detector, configured to detect the position of the access barrier and to generate an access barrier status signal indicative of the access barrier being open or closed in response to the detected position of the access barrier;
a lock position detector, configured to detect the position of a lock operatively coupled to the access barrier for selectively locking and unlocking the access barrier and to generate a lock status signal indicative of the access barrier being locked or unlocked in response to the detected position of the lock; and
a signal transmitter, configured to transmit the access barrier status signal and the lock status signal.

2. The security device of claim 1, wherein the access barrier is a window and the access barrier position detector includes a magnetic switch mounted to one of an upper frame member and a lower frame member of the window and a corresponding magnetic member mounted to the other of the upper frame member and a lower frame member.

3. The security device of claim 2, wherein the lock position detector includes a magnetic switch mounted to one of a support member and a latch of the lock and a corresponding magnetic member mounted to the other of the support member and the latch.

4. The security device of claim 3, wherein the lock position detector includes a contact switch mounted to one of the support member and the latch.

5. A security system for monitoring a protected area, comprising:
a security device used in connection with an access barrier of the protected area, the access barrier movable between an open position and a closed position for selectively permitting ingress and egress to the protected area, comprising:
an access barrier position detector configured to detect the position of an access barrier and to generate an access barrier status signal indicative of the access barrier being open or closed in response to the detected position of the access barrier;
a lock position detector configured to detect the position of a lock operatively coupled to the access barrier for selectively locking and unlocking the access barrier and to generate a lock status signal indicative of the access barrier being locked or unlocked in response to the detected position of the lock;
a signal transmitter configured to transmit the access barrier status signal and the lock status signal,
a control panel in communication with the security device, comprising:
a signal transceiver configured to receive and transmit the access barrier status signal and the lock status signal transmitted by the signal transmitter; and
a processor configured to process the access barrier status signal and the lock status signal and generate a security status message of the monitored area based on the processing of the access barrier status signal and the lock status signal.

6. The system of claim 5, wherein the processor generates a security status message indicating that the monitored area is secure if the access barrier status signal indicates that the access barrier is closed and the lock status signal indicates that the access barrier is locked.

7. The system of claim 5, further comprising a display in communication with the processor for displaying the security status message of the monitored area.

8. The system of claim 5, further comprising a user interface for a user to arm or disarm the security system.

9. The system of claim 5, further comprising a central monitoring station in communication with the control panel, for receiving and processing the security status message.

10. The system of claim 5, wherein the access system includes a window and the access barrier position detector includes a magnetic switch mounted to one of an upper frame member and a lower frame member of the window and a corresponding magnetic member mounted to the other of the upper frame member and a lower frame member.

11. The system of claim 10, wherein the lock position detector includes a magnetic switch mounted to one of a support member and a latch of the lock and a corresponding magnetic member mounted to the other of the support member and the latch.

12. The system of claim 11, wherein the lock position detector includes a contact switch mounted to one of the support member and the latch.

13. A method for monitoring an access barrier of a protected area, comprising:
detecting the position of the access barrier;
generating an access barrier status signal indicative of the access barrier being open or closed in response to the detected position of the access barrier;
detecting the position of a lock of the access barrier for selectively locking and unlocking the access door;
generating a lock status signal indicative of the access barrier being locked or unlocked in response to the detected position of the lock;
processing the access barrier status signal and the lock status signal to generate a security status message of the monitored area.

14. The method of claim 13, further comprising displaying the secure status message.

15. The method of claim 14, further comprising sending the secure status message to a central monitoring station.
